(19) United States
(12) Patent Application Publication
(10) Pub. No.: US 2026/0371117 A1
(43) Pub. Date: Nov. 19, 2026

(54) METHOD AND APPARATUS FOR POSITIONING

(71) Applicant: Samsung Electronics Co., Ltd., Suwon-si, Gyeonggi-do (KR)

(72) Inventors: Qi XIONG, Beijing (CN); Feifei SUN, Beijing (CN)

(21) Appl. No.: 19/145,758

(22) PCT Filed: Jan. 12, 2024
(86) PCT No.: PCT/KR2024/000645

§ 371 Date: Jul. 3, 2025

(30) Foreign Application Priority Data
Jan. 19, 2023 (CN) 202310098171.1

(51) Int. Cl. H04W 24/08; H04B 17/391

(52) U.S. Cl. CPC H04W 24/08; H04B 17/391

(57) ABSTRACT

The present disclosure provides a method performed by a node in a communication system, including: obtaining a monitoring result with regard to a model used by a first type of method based on a first event; and performing an operation related to the model based on the monitoring result, wherein the first event includes at least one of: event A: monitoring data for the model satisfying a first condition; event B: an operating duration and/or a number of operating times of the model satisfying a second condition; event C: a number of occurrences of the event A satisfying a third condition.

### TECHNICAL FIELD

The present disclosure relates to a method and an apparatus for positioning in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedure (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

According to an embodiment of the present disclosure, a method performed by a node in a communication system is provided, the method comprising: obtaining a monitoring result with regard to a model used by a first type of method based on a first event; and performing an operation related to the model based on the monitoring result, wherein the first event includes at least one of: event A: monitoring data for the model satisfying a first condition; event B: an operating duration and/or a number of operating times of the model satisfying a second condition; or event C: a number of occurrences of the event A satisfying a third condition.

In an embodiment of the present disclosure, wherein the operating duration and/or the number of operating times of the model satisfying the second condition includes: the operating duration not exceeding a first time threshold, and/or the number of operating times not exceeding a first threshold for number of times.

In an embodiment of the present disclosure, wherein the number of occurrences of the event A satisfying the third condition includes: the number of occurrences of the event A not exceeding a second threshold for number of times.

In an embodiment of the present disclosure, wherein the monitoring data includes at least one of: information related to model input information; information related to model output information; a reference signal received power (RSRP) and/or a reference signal received quality (RSRQ) obtained by measuring a second signal; or a signal-to-noise ratio (SNR) and/or a signal to interference plus noise ratio (SINR) obtained by measuring the second signal, wherein the information related to the model input information includes at least one of: a data type; a data size; a data distribution; or a data quality including a number or ratio of the data higher than a certain threshold value, and wherein the information related to the model output information includes at least one of: location information; or a measured value related to a location.

In an embodiment of the present disclosure, wherein the node obtains the monitoring data by: obtaining the monitoring data through reports received from other nodes; and/or obtaining the monitoring data by measuring a second signal.

In an embodiment of the present disclosure, wherein the monitoring data satisfying the first condition includes at least one of: a difference between a positioning location corresponding to positioning information included in the monitoring data and a predetermined positioning location being not greater than a second threshold, or the difference being within an uncertainty range of location information; a number of data corresponding to model input information included in the monitoring data satisfying a threshold of number and/or a type thereof satisfying a type group; the monitoring data including input information on the model provided by not less than a first number of entities; the monitoring data including not less than a second number of measurement results for a second signal; or the monitoring data including not less than a third number of channel impulse response (CIR)/RSRP/angle related information/phase related information.

In an embodiment of the present disclosure, wherein the monitoring data is obtained based on configuration information related to monitoring the model, and wherein the configuration information includes at least one of: configuration information of a second signal for monitoring the model; resource configuration information for reporting a measurement result of the second signal; monitored model related information; or configuration information of a measurement/monitoring gap (MG) and/or a positioning reference signal (PRS) processing window (PPW) for monitoring the model.

In an embodiment of the present disclosure, wherein the monitored model related information includes at least one of: information related to composition of models of the first type of method or models that need to be monitored, including a number and/or index information of the models; a type of the model of the first type of method; hyperparameter configuration information; a data set related parameter; or a weight parameter and/or bias parameter configuration.

In an embodiment of the present disclosure, wherein monitoring the model is triggered based on at least one of: the first type of method and/or at least one of models of the first type of method being valid; a first trigger condition being satisfied; or a number of times the first trigger condition is satisfied being not less than a fourth number, wherein the first trigger condition includes at least one of: an RSRP value of a measured first signal being not less than a first threshold value; a pathloss of the measured first signal being not greater than a second threshold value; or a number of entities related to monitoring the model being not less than a fifth number.

In an embodiment of the present disclosure, wherein the entities related to monitoring the model include an entity satisfying at least one of: having known location information; reporting that it has a capability as an entity for monitoring the model; a state indicator as the entity for monitoring the model being active or available; being in a coverage area of a same cell or cell group as the node; having a same serving cell as the node and/or being in a same cell group as a serving cell of the node; being capable of receiving and measuring a first signal and/or transmitting the first signal; the measured first signal satisfying a condition related to a signal characteristic; or a transmission and/or reception characteristic of the first signal satisfying a condition related to a transmission error and/or reception error of a signal.

In an embodiment of the present disclosure, wherein performing the operation related to the model based on the monitoring result includes: when the monitoring result is not pass monitoring, or when a number of times the monitoring result being not pass monitoring reaches an eighth number, performing at least one of: terminating use of the model; initiating model fine-tuning; or initiating model switching.

According to an embodiment of the present disclosure, an electronic device is provided, including: a transceiver configured to transmit and/or receive signals; a controller coupled with the transceiver and configured to perform the operations in the methods described according to the embodiments of the present disclosure.

A non-transitory computer-readable medium storing computer-executable instructions which, when executed by a processor, cause the processor to perform the operations in the methods described according to the embodiments of the present disclosure.

### BRIEF DESCRIPTION OF DRAWINGS

FIG. 1 illustrates an example wireless network according to various embodiments of the present disclosure;

FIGS. 2a and 2b illustrate example wireless transmission and reception paths according to the present disclosure;

FIG. 3a illustrates an example user equipment according to the present disclosure and FIG. 3b illustrates an example base station according to the present disclosure;

FIG. 4 illustrates a schematic diagram of a method according to an embodiment of the present disclosure; and

FIG. 5 is a block diagram illustrating an electronic device according to an embodiment of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or features. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical solutions of the embodiments of the present application can be applied to future-oriented communication technologies. In addition, the technical solutions of the embodiments of the present application can be applied to future-oriented communication technologies.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

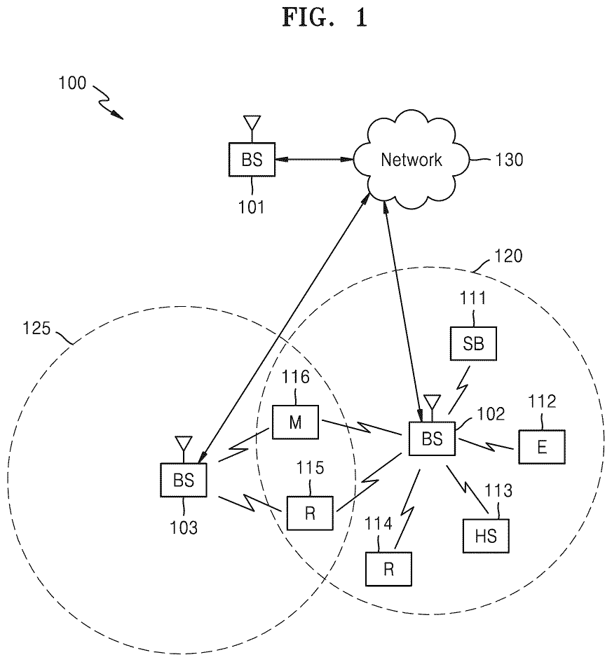

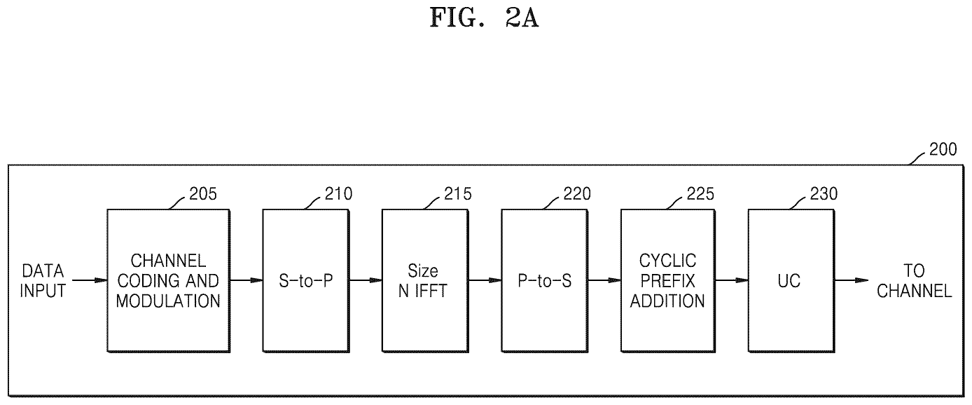

FIG. 1 illustrates an example of wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 may include a gNodeB (gNB) 101, a gNB 102, and a gNB 103. gNB 101 may communicate with gNB 102 and gNB 103. gNB 101 may also communicate with at least one Internet Protocol (IP) network 130, such as the Internet, a private IP network, or other data networks.

Depending on a type of the network, other well-known terms such as “base station” or “access point” may be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” may be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 may provide wireless broadband access to the network 130 for a first plurality of User Equipments (UEs) within a coverage area 120 of gNB 102. The first plurality of UEs may include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. gNB 103 may provide wireless broadband access to network 130 for a second plurality of UEs within a coverage area 125 of gNB 103. The second plurality of UEs may include a UE 115 and a UE 116. In some embodiments, one or more of gNBs 101-103 may communicate with each other and with UEs 111-116 using 5G, Long Term Evolution (LTE), LTE-A, WiMAX or other advanced wireless communication technologies such as 5G-Advanced or 6G system.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 may include a two-dimensional (2D) antenna array as described in embodiments of the present disclosure. In some embodiments, one or more of gNB 101, gNB 102, and gNB 103 may support codebook designs and structures for systems with 2D antenna arrays.

Although FIG. 1 illustrates an example of the wireless network 100, various changes may be made to FIG. 1. The wireless network 100 may include any number of gNBs and any number of UEs in any suitable arrangement, for example. Furthermore, gNB 101 may directly communicate with any number of UEs and provide wireless broadband access to the network 130 for those UEs. Similarly, each gNB 102-103 may directly communicate with the network 130 and provide direct wireless broadband access to the network 130 for the UEs. In addition, gNB 101, 102 and/or 103 may provide access to other or additional external networks, such as external telephone networks or other types of data networks.

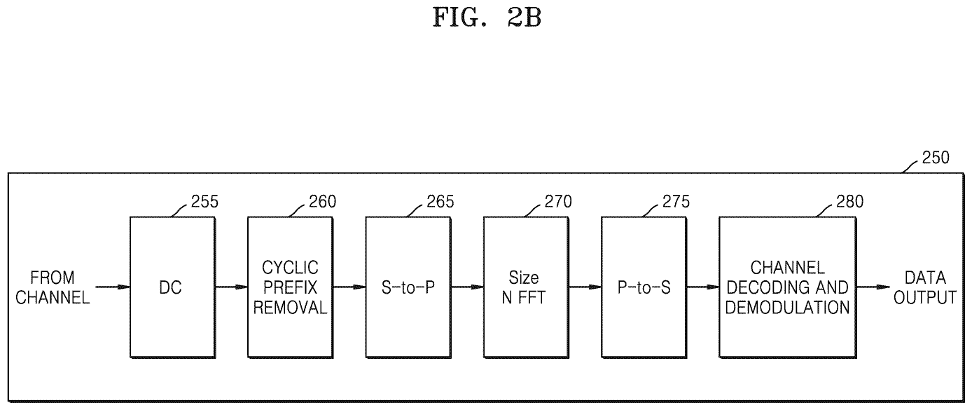

FIGS. 2a and 2b illustrate examples of wireless transmission and reception paths according to the present disclosure. In the following description, the transmission path 200 may be described as being implemented in a gNB, such as gNB 102, and the reception path 250 may be described as being implemented in a UE, such as UE 116. However, it should be understood that the reception path 250 may be implemented in a gNB and the transmission path 200 may be implemented in a UE. In some embodiments, the reception path 250 may be configured to support codebook designs and structures for systems with 2D antenna arrays as described in embodiments of the present disclosure.

The transmission path 200 may include a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 may include a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 may receive a set of information bits, apply coding (such as Low Density Parity Check (LDPC) coding), and modulate the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 may convert (such as demultiplexes) serial modulated symbols into parallel data to generate N parallel symbol streams, where N is a size of the IFFT/FFT used in gNB 102 and UE 116. The size N IFFT block 215 may perform IFFT operations on the N parallel symbol streams to generate a time-domain output signal. The Parallel-to-Serial block 220 may convert (such as multiplexes) parallel time-domain output symbols from the Size N IFFT block 215 to generate a serial time-domain signal. The cyclic prefix addition block 225 may insert a cyclic prefix into the time-domain signal. The up-converter 230 may modulate (such as up-converts) the output of the cyclic prefix addition block 225 to a radio frequency (RF) frequency for transmission via a wireless channel. The signal can also be filtered at a baseband before switching to the RF frequency.

The RF signal transmitted from gNB 102 may arrive at UE 116 after passing through the wireless channel, and operations in reverse to those at gNB 102 may be performed at UE 116. The down-converter 255 may down-convert the received signal to a baseband frequency, and the cyclic prefix removal block 260 may remove the cyclic prefix to generate a serial time-domain baseband signal. The Serial-to-Parallel block 265 may convert the time-domain baseband signal into a parallel time-domain signal. The Size N FFT block 270 may perform fast Fourier transform (FFT) algorithm to generate N parallel frequency-domain signals. The Parallel-to-Serial block 275 may convert the parallel frequency-domain signal into a sequence of modulated data symbols. The channel decoding and demodulation block 280 may demodulate and decode the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b may be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and inverse FFT (IFFT), this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b may be combined, further subdivided or omitted, and additional components may be added according to specific requirements. Furthermore, FIGS. 2a and 2b are intended to illustrate examples of types of transmission and reception paths that may be used in a wireless network. Any other suitable architecture may be used to support wireless communication in a wireless network.

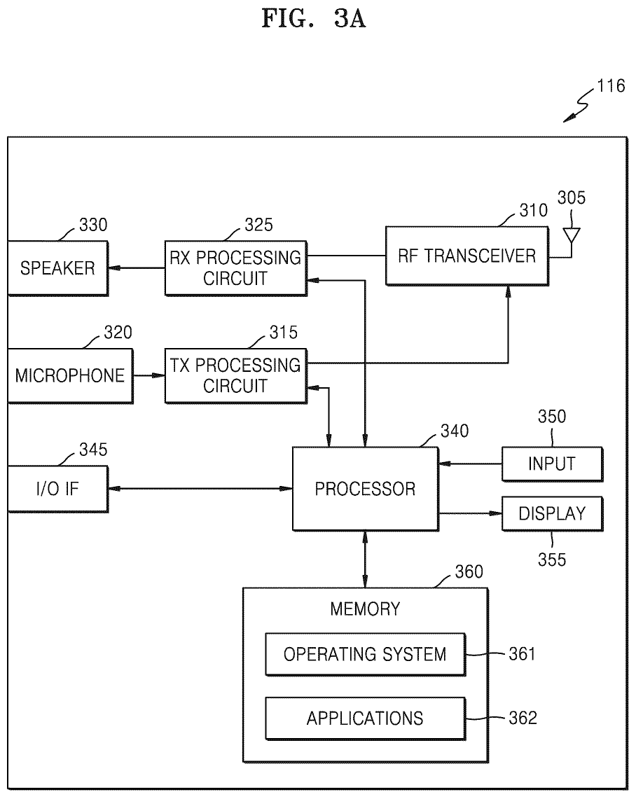

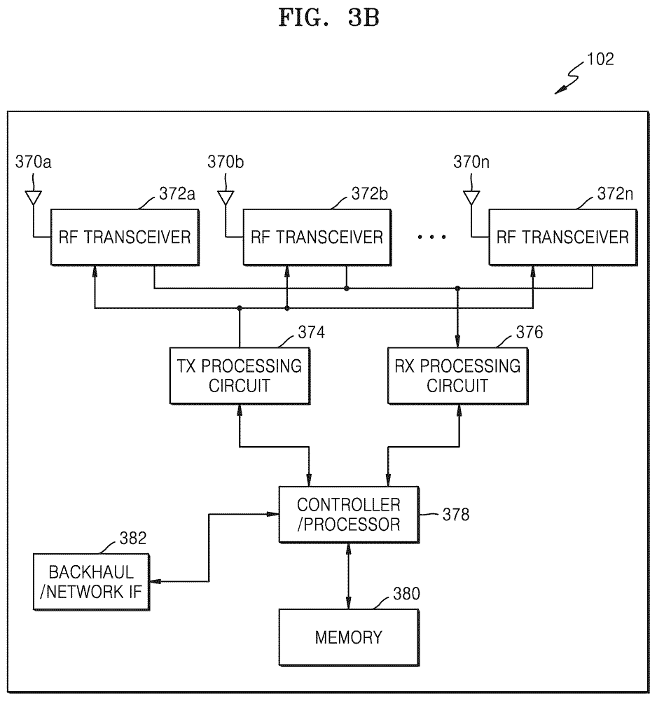

FIG. 3a illustrates an example of UE 116 according to the present disclosure. The embodiment of UE 116 shown in FIG. 3a is for illustration only, and UEs 111-115 of FIG. 1 may have the same or similar configuration. However, a UE may have various configurations, and FIG. 3a does not limit the scope of the present disclosure to any specific implementation of the UE.

UE 116 may include an antenna 305, a radio frequency (RF) transceiver 310, a transmission (TX) processing circuit 315, a microphone 320, and a reception (RX) processing circuit 325. UE 116 may also include a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 may receive an incoming RF signal transmitted by a gNB of the wireless network 100 from the antenna 305. The RF transceiver 310 may down-convert the incoming RF signal to generate an intermediate frequency (IF) or baseband signal. The IF or baseband signal may be transmitted to the RX processing circuit 325, where the RX processing circuit 325 may generate a processed baseband signal by filtering, decoding and/or digitizing the baseband or IF signal. The RX processing circuit 325 may transmit the processed baseband signal to speaker 330 (such as for voice data) or to processor/controller 340 for further processing (such as for web browsing data).

The TX processing circuit 315 may receive analog or digital voice data from microphone 320 or other outgoing baseband data (such as network data, email or interactive video game data) from processor/controller 340. The TX processing circuit 315 may encode, multiplex, and/or digitize the outgoing baseband data to generate a processed baseband or IF signal. The RF transceiver 310 may receive the outgoing processed baseband or IF signal from the TX processing circuit 315 and may up-convert the baseband or IF signal into an RF signal transmitted via the antenna 305.

The processor/controller 340 may include one or more processors or other processing devices and execute an operating system (OS) 361 stored in the memory 360 in order to control the overall operation of UE 116. For example, the processor/controller 340 may control the reception of forward channel signals and the transmission of backward channel signals through the RF transceiver 310, the RX processing circuit 325 and the TX processing circuit 315 according to well-known principles. In some embodiments, the processor/controller 340 may include at least one microprocessor or microcontroller.

The processor/controller 340 may be also capable of executing other processes and programs residing in the memory 360, such as operations for channel quality measurement and reporting for systems with 2D antenna arrays as described in embodiments of the present disclosure. The processor/controller 340 may move data into or out of the memory 360 as required by an execution process. In some embodiments, the processor/controller 340 may be configured to execute the application 362 based on the OS 361 or in response to signals received from the gNB or the operator. The processor/controller 340 may be also coupled to an I/O interface 345, where the I/O interface 345 may provide UE 116 with the ability to connect to other devices such as laptop computers and handheld computers. I/O interface 345 may be a communication path between these accessories and the processor/controller 340.

The processor/controller 340 may be also coupled to the input device(s) 350 and the display 355. An operator of UE 116 may input data into UE 116 using the input device(s) 350. The display 355 may be a liquid crystal display or other display capable of presenting text and/or at least limited graphics (such as from a website). The memory 360 may be coupled to the processor/controller 340. A part of the memory 360 may include a random access memory (RAM), while another part of the memory 360 may include a flash memory or other read-only memory (ROM).

Although FIG. 3a illustrates an example of UE 116, various changes may be made to FIG. 3a. For example, various components in FIG. 3a may be combined, further subdivided or omitted, and additional components may be added according to specific requirements. As a specific example, the processor/controller 340 may be divided into a plurality of processors, such as one or more central processing units (CPUs) and one or more graphics processing units (GPUs). Furthermore, although FIG. 3a illustrates that the UE 116 is configured as a mobile phone or a smart phone, UEs may be configured to operate as other types of mobile or fixed devices.

FIG. 3b illustrates an example of gNB 102 according to the present disclosure. The embodiment of gNB 102 shown in FIG. 3b is for illustration only, and other gNBs of FIG. 1 may have the same or similar configuration. However, a gNB may have various configurations, and FIG. 3b does not limit the scope of the present disclosure to any specific implementation of a gNB. It should be noted that gNB 101 and gNB 103 may include the same or similar structures as gNB 102.

As shown in FIG. 3b, gNB 102 may include a plurality of antennas 370a-370n, a plurality of RF transceivers 372a-372n, a transmission (TX) processing circuit 374, and a reception (RX) processing circuit 376. In certain embodiments, one or more of the plurality of antennas 370 a-370n may include a 2D antenna array. gNB 102 may also include a controller/processor 378, a memory 380, and a backhaul or network interface 382.

RF transceivers 372a-372n may receive an incoming RF signal from antennas 370a-370n, such as a signal transmitted by UEs or other gNBs. RF transceivers 372a-372n may down-convert the incoming RF signal to generate an IF or baseband signal. The IF or baseband signal may be transmitted to the RX processing circuit 376, where the RX processing circuit 376 may generate a processed baseband signal by filtering, decoding and/or digitizing the baseband or IF signal. RX processing circuit 376 may transmit the processed baseband signal to controller/processor 378 for further processing.

The TX processing circuit 374 may receive analog or digital data (such as voice data, network data, email or interactive video game data) from the controller/processor 378. TX processing circuit 374 may encode, multiplex and/or digitize outgoing baseband data to generate a processed baseband or IF signal. RF transceivers 372a-372n may receive the outgoing processed baseband or IF signal from TX processing circuit 374 and up-convert the baseband or IF signal into an RF signal transmitted via antennas 370a-370n.

The controller/processor 378 may include one or more processors or other processing devices that control the overall operation of gNB 102. For example, the controller/processor 378 may control the reception of forward channel signals and the transmission of backward channel signals through the RF transceivers 372a-372n, the RX processing circuit 376 and the TX processing circuit 374 according to well-known principles. The controller/processor 378 may also support additional functions, such as higher-level wireless communication functions. For example, the controller/processor 378 may perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 may include at least one microprocessor or microcontroller.

The controller/processor 378 may be also capable of executing programs and other processes residing in the memory 380, such as a basic OS. The controller/processor 378 may also support channel quality measurement and reporting for systems with 2D antenna arrays as described in embodiments of the present disclosure. In some embodiments, the controller/processor 378 may support communication between entities such as web RTCs. The controller/processor 378 may move data into or out of the memory 380 as required by an execution process.

The controller/processor 378 may be also coupled to the backhaul or network interface 382. The backhaul or network interface 382 may allow gNB 102 to communicate with other devices or systems through a backhaul connection or through a network. The backhaul or network interface 382 may support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 may allow gNB 102 to communicate with other gNBs through wired or wireless backhaul connections. When gNB 102 is implemented as an access point, the backhaul or network interface 382 may allow gNB 102 to communicate with a larger network, such as the Internet, through a wired or wireless local area network or through a wired or wireless connection. The backhaul or network interface 382 may include any suitable structure that supports communication through a wired or wireless connection, such as an Ethernet or an RF transceiver.

The memory 380 may be coupled to the controller/processor 378. A part of the memory 380 may include an RAM, while another part of the memory 380 may include a flash memory or other ROMs. In certain embodiments, a plurality of instructions, such as the BIS algorithm, may be stored in the memory. The plurality of instructions may be configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) may support aggregated communication with FDD cells and TDD cells.

Although FIG. 3b illustrates an example of gNB 102, various changes may be made to FIG. 3b. For example, gNB 102 may include any number of each component shown in FIG. 3a. As a specific example, the access point may include many backhaul or network interfaces 382, and the controller/processor 378 may support routing functions to route data between different network addresses. As another specific example, although shown as including a single instance of the TX processing circuit 374 and a single instance of the RX processing circuit 376, gNB 102 may include multiple instances of each (such as one for each RF transceiver).

The time-domain unit (also called time unit) in the present disclosure may be: an OFDM symbol, an OFDM symbol group (comprising multiple OFDM symbols), a slot, a slot group (comprising multiple slots), a subframe, a subframe group (comprising multiple subframes), a system frame and a system frame group (comprising multiple system frames); it may also be an absolute time unit, such as 1 millisecond, 1 second, etc. ; the time unit may also be a combination of multiple granularities, such as N1 slots plus N2 OFDM symbols.

The frequency-domain unit (also called frequency unit) in the present disclosure may be: a subcarrier, a subcarrier group (comprising multiple subcarriers), a resource block (RB) (which may also be called a physical resource block (PRB)), a resource block group (comprising multiple RBs), a bandwidth part (BWP), a bandwidth part group (comprising multiple BWPs), a band/carrier, a band group/carrier group; it may also be an absolute frequency-domain unit, such as 1 Hz, 1 kHz, etc.; the frequency-domain unit may also be a combination of multiple granularities, such as M1 PRBs plus M2 subcarriers.

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples may be made without departing from the scope of the present disclosure.

It can be understood by those skilled in the art that the singular forms “a,” “an,” “said” and “the” used herein can also include plural forms, unless specifically stated. It should be further understood that the wording “include” used in the specification of the present disclosure refers to the presence of said features, integers, steps, operations, elements and/or components, but does not exclude the presence or addition of one or more other features, integers, steps, operations, elements, components and/or groups thereof. It should be understood that when an element is said to be “connected” or “coupled” to another element, it can be directly connected or coupled to the other element, or there may be intermediate elements. Furthermore, “connect” or “couple” used herein may include wireless connection or wireless coupling. The wording “and/or” used herein includes all or any unit and all combinations of one or more associated listed items.

It can be understood by those skilled in the art that all terms (including technical terms and scientific terms) used herein have the same meaning as commonly understood by those of ordinary skill in the art to which the present disclosure belongs, unless otherwise defined. It should also be understood that the terms, such as those defined in general dictionaries, should be understood as having meanings consistent with those in the context of the prior art, and will not be interpreted in an idealized or overly formal sense unless they are specifically defined as here.

It can be understood by those skilled in the art that the “terminal” and “terminal device” used herein may include both a device of a wireless signal receiver, which only has a device of a wireless signal receiver without transmission capability, and a device of a receiving and transmitting hardware, which has a device of a receiving and transmitting hardware capable of bidirectional communication on a bidirectional communication link. Such devices may include a cellular or other communication device having a single-line display or a multi-line display or a cellular or other communication device without a multi-line display; a personal communications service (PCS), which can combine voice, data processing, fax and/or data communication capabilities; a personal digital assistant (PDA), which can include an RF receiver, a pager, Internet/Intranet access, a web browser, a notepad, a calendar and/or a global positioning system (GPS) receiver; a conventional laptop and/or palmtop computer or other device having and/or including a conventional laptop and/or palmtop computer or other device of a radio frequency receiver. The “terminal” and “terminal device” used herein may be portable, transportable, installed in vehicles (air, sea and/or land), or suitable and/or configured to run locally, and/or run in any other location on the earth and/or space in a distributed form. The “terminal” and “terminal device” used herein may also be a communication terminal, an internet terminal and a music/video playing terminal, such as a PDA, a mobile Internet device (MID) and/or a mobile phone with music/video playing function, as well as a smart TV, a set-top box and other devices.

Without departing from the scope of the present disclosure, the term “transmit” in the present disclosure may be used interchangeably with “transport”, “report” and “notify”.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples may be made without departing from the scope of the present disclosure.

The transmission links of the wireless communication system mainly include: a downlink communication link from a 5G gNB to a User Equipment (UE) and an uplink communication link from a UE to a network.

The nodes for positioning measurement in the wireless communication system, such as a current wireless communication system, may include: a UE that initiates a positioning request message, a Location Management Function (LMF) that is used for UE positioning and positioning assistance data transmission, a gNB or Transmission-Reception Point (TRP) that broadcasts positioning assistance data and performs uplink positioning measurement, and a UE that is used for downlink positioning measurement. In addition, the method in the present disclosure may also be extended to other communication systems, such as automobile communication system (e.g., vehicle-to-everything (V2X) communication system), that is, sidelink communication system, in which the transmission-reception point or UE may be any device in V2X.

In recent years, artificial intelligence (AI) technology, represented by deep learning algorithm, has risen again, which has solved the problems that have existed in all walks of life for many years and achieved great technical and commercial success. With the continuous evolution of the wireless communication system, these problems in the air interface have been studied and it has tried to introduce new methods to solve them. In order to solve some problems encountered in communication, the method of machine learning may be enabled. The method of machine learning (ML) may usually refer to the algorithm design including machine learning and the machine learning model design on which the algorithm is based. The solution based on AI deep learning (DL) technology may usually refer to the algorithm based on an artificial neural network model in the machine learning technology. The deep learning network model may be usually composed of artificial neural networks with multiple layers stacked. The weight parameters in the neural network are adjusted by training the existing data, and then used to achieve the task goal in the inferrring stage in the situations that have not been met yet. At the same time, in general, compared with the general solution or algorithm based on fixed rules, the solution based on DL needs better computing capability than the original classical algorithm, which may usually require a dedicated computing chip in the device operating DL algorithm to support the more efficient operation of DL algorithm.

Using AI algorithm based on machine learning to solve the problems encountered in communication may usually need to meet the conditions of machine learning problems. Among the problems related to air interface in communication, acquiring device positioning may be a typical one that meets the above conditions to a certain extent, so they can be solved by machine learning algorithm, and better effects than traditional solutions can be achieved in the process of communication transmission, for example, in the environment of non-line-of-sight path.

Although for the currently used wireless communication system, the traditional positioning algorithm can provide normal services in some scenarios; however, for the machine learning algorithm, because it is completely different from the architecture and characteristics of the traditional algorithm, its usage method may be completely different from the traditional algorithm. The current wireless communication systems (the fourth generation, the fifth generation, and possibly the future sixth generation wireless communication systems) have strict and unified standards to restrict the configuration method and behavior process of the air interface in the communication process. Therefore, considering the new technology using machine learning in the new generation wireless communication system, the design of the air interface must be combined with the characteristics of the new communication system and machine learning algorithm. When the technology based on machine learning is implemented in the communication system, there may be still a need to monitor the model, such as how to determine whether the machine learning algorithm model is suitable for the current environment, whether the model works well, whether the model needs to be switched, fine-tuned, terminated and so on. Accordingly, solutions are needed to enable nodes (for example, entities deployed with machine learning models, such as a UE, a base station, a network-side entity, etc.) to monitor the used models.

Therefore, based on the above problems, in order to use the solutions based on machine learning in the wireless communication system, it is necessary to propose effective technical methods to specify the specific methods and processes that need to exist for implementing these solutions in the system, so as to establish a suitable framework for solving the air interface related problems in a wireless communication by the method based on machine learning.

Herein, a first type of method is used to include expressions such as “machine learning based algorithm and model”, “AI (artificial intelligence)/ML (machine learning) based technology”, “AI/ML for NR air interface”, “AI/ML technology”, “AI/ML architecture”, “AI/ML model”, “AI/ML for air interface”, “AI/ML method” and “AI/ML related algorithm”, “AI/ML based algorithm” and “AI/ML solution”, etc., which may also be understood as that the expression “first type of method” includes any of the above listed expressions.

The present disclosure provides a method for monitoring machine learning algorithms and/or models in a wireless communication system (for example, machine learning algorithms and/or models for implementing positioning operations and acquisition of positioning information of the wireless communication system, etc.). The purpose of the present disclosure may be to solve the problem of how to determine whether the current AI/ML model is a suitable model in a wireless communication system, so that communication-related solutions based on machine learning (for example, positioning methods) can be better applicable to various practical wireless communication systems.

It should be understood that throughout the description of the present disclosure, expressions such as “model of a first type of method”, “AI model”, “AI/ML model” and “algorithm and/or model” all may refer to one or more models involved in the first type of method, or a part of multiple models involved in the first type of method.

In an embodiment of the present disclosure, a first type of method used in a wireless communication system is considered for positioning-related operations and/or positioning information acquisition, but with the change of the time and/or surrounding environment, it may cause that an AI/ML model of the used first type of method is no longer applicable. The monitoring of performance of the AI/ML model used by the first type of method proposed in the present disclosure enables an entity using and/or deploying the first type of method to know the applicable situation of the current AI/ML model more timely and take corresponding operations in time.

The entity using and/or deploying the first type of method (denoted as entity A in the present disclosure) introduced by the present disclosure includes one or more of the following parts (stages or modes or operations) when monitoring the AI model of the used first type of method:
>monitoring trigger (or monitoring enabling, trigger is used as an example in the present disclosure); in the triggering part, whether to trigger monitoring of an AI/ML model used by the first type of method is determined, and/or whether conditions for triggering the monitoring of the AI/ML model used by the first type of method are satisfied is determined; optionally, in this part, one or more of the following operations may be included:
>>determining whether to trigger the monitoring of the AI/ML model used by the first type of method; the entity A determines to trigger the above monitoring under one or more of the following conditions:
>>>when the entity A receives activation signaling (PDCCH, MAC CE and/or higher layer signaling) with regard to using of the first type of method (and/or the model of the first type of method) from other devices,
>>>when the entity A receives activation signaling (PDCCH, MAC CE and/or high-level signaling) with regard to monitoring of the first type of method (and/or the model of the first type of method) from other devices;
>>>when the entity A determines and/or activates using of the first type of method (and/or the model of the first type of method) and/or uses the first type of method (and/or the model of the first type of method);
>>>when the entity A determines and/or activates using of the first type of method (and/or the model of the first type of method) and/or uses the first type of method (and/or the model of the first type of method), and the model is valid;
>>determining whether the conditions for triggering the monitoring of the AI/ML model used by the first type of method are satisfied; in a case that the conditions for triggering the monitoring of the AI/ML model used by the first type of method are satisfied, the monitoring of the AI/ML model used by the first type of method is determined to be triggered; otherwise, if the conditions for triggering the monitoring of the AI/ML model used by the first type of method are not satisfied, the monitoring of the AI/ML model used by the first type of method is not triggered. The advantage of this is at least to make the monitoring of the AI/ML model used by the first type of method more targeted, so that the monitoring can be performed under appropriate circumstances and invalid or useless monitoring can be avoided;
optionally, the conditions for triggering the monitoring of the AI/ML model used by the first type of method (also referred to as “trigger conditions”) may include one or more of:
>>>a reference signal received power (RSRP) value of a measured first signal being not less than (or greater than) a first threshold value; optionally, the reference signal received power of the first signal may include a reference signal received power of a first path and/or reference signal received powers of X paths; in an example, the first path may be a path with a strongest signal strength, or a path with an earliest arrival time (for example, a minimum path delay), or a path with an earliest arrival time (for example, a minimum path delay) among paths with a signal strength higher than a threshold. The X paths may be X paths with a maximum path impulse response amplitude (and/or reference signal received power) and/or X paths with a minimum path delay (or earliest arrival time), or X paths with a minimum path delay (or earliest arrival time) among paths with a signal strength higher than a threshold; the first threshold value and/or threshold is obtained by receiving an instruction and/or preset; the advantage of this is at least to avoid the monitoring of the AI/ML model used by the first type of method when the channel conditions are poor, resulting in inaccurate monitoring results; optionally, when the reference signal received power (RSRP) value of the measured first signal is less than (or not greater than) the first threshold value, the monitoring of the AI/ML model used in the first type of method may not be triggered; the RSRP, signal strength, path impulse response amplitude and channel impulse response (CIR) amplitude may be replaced by each other.
>>>a pathloss of a measured first signal being not greater than (or less than) a second threshold value, optionally, the pathloss of the first signal may include a pathloss of a first path and/or pathlosses of X paths; the X paths may be X paths with a maximum path impulse response and/or X paths with a minimum path delay; the second threshold value may be obtained by receiving an instruction and/or preset; the advantage of this is at least to avoid the monitoring of the AI/ML model used by the first type of method when the channel conditions are poor, resulting in inaccurate monitoring results; optionally, when the pathloss of the measured first signal is greater than (or not less than) the second threshold value, the monitoring of the AI/ML model used in the first type of method may not be triggered;
>>>the number of entities related to the monitoring of the AI/ML model used by the first type of method being greater than (or not less than) N1; N1 is a positive integer, for example, N1=1; N1 is obtained by receiving an instruction and/or preset; optionally, the entity related to the monitoring of the AI/ML model used by the first type of method may be an entity satisfying at least one of the following conditions:
>>>>having known (or determined) location information;
>>>>having reported that it has a capability as a monitoring entity;
>>>>a state indicator as a monitoring entity being active or available (for example, on, available, etc.);
>>>>satisfying certain state conditions, which include one or more of:
>>>>>being in a coverage area of the same cell or cell group (including one or more cells) as the entity A;
>>>>>having the same serving cell as the entity A and/or being in the same cell group (including one or more cells) as a serving cell of the entity A;
>>>>>being capable of receiving and measuring the first signal and/or transmitting the first signal;
>>>>a feature of a measured and/or received and/or transmitted first signal satisfying conditions of being an entity related to the monitoring of the AI/ML model used by the first type of method; optionally, the conditions of being the entity related to the monitoring of the AI/ML model used by the first type of method may be obtained by receiving instructions and/or preset; optionally, specifically, the conditions may be one or more of:
>>>>>the condition of being the entity related to the monitoring of the AI/ML model used by the first type of method is that the first signal measured by the entity is a single-path signal; alternatively, in another example, the condition is that the first signal measured by the entity is a multi-path signal. For example, when the measured first signal is the single-path signal (or multi-path signal), the condition is satisfied, otherwise, the condition is not satisfied; specifically, including that the measured first signal has only one path; or the measured first signal has multiple paths, but an arrival time and/or a received power value of only one path satisfies a threshold value; the threshold value is obtained by receiving an instruction and/or preset;
>>>>>the condition of being the entity related to the monitoring of the AI/ML model used by the first type of method is that the first signal measured by the entity is a line-of-sight signal; alternatively, in another example, the condition is that the first signal measured by the entity is a non-line-of-sight signal. For example, when the measured first signal is the line-of-sight (LoS) signal (or non-line-of-sight (NLoS) signal), the condition is satisfied, otherwise, the condition is not satisfied; for example, including: when an LoS/NLOS indicator is true, that is, the measured first signal is the line-of-sight signal (for example, when the indicator is a hard indicator, it indicates LoS); and/or a value of the line-of-sight/non-line-of-sight indicator (for example, when the indicator is a soft indicator) is greater than (or not less than) a probability threshold value, that is, when the measured first signal has a high probability of being the line-of-sight; similarly, when the LoS/NLOS indicator is false, that is, the measured first signal is the non-line-of-sight signal (for example, when the indicator is a hard indicator, it indicates NLoS); and/or the value of the line-of-sight/non-line-of-sight indicator (for example, when the indicator is a soft indicator) is not greater than (less than) a probability threshold value, that is, when the measured first signal has a high probability of being the non-line-of-sight; the threshold value is obtained by receiving an instruction and/or preset;
>>>>>the condition of being the entity related to the monitoring of the AI/ML model used by the first type of method is that a reference signal received power (RSRP) value of the first signal measured by the entity is greater than (or not less than) a threshold value; alternatively, in another example, the condition is that the reference signal received power (RSRP) value of the first signal measured by the entity is less than (or not greater than) a threshold value; when the reference signal received power (RSRP) value of the measured first signal is greater than (or not less than) a threshold value (or less than (or not greater than) a threshold value), the condition is satisfied, otherwise, the condition is not satisfied; the threshold value is obtained by receiving an instruction and/or preset;
>>>>>the condition of being the entity related to the monitoring of the AI/ML model used by the first type of method is that a pathloss value of the first signal measured by the entity is less than (or not greater than) a threshold value; alternatively, in another example, the condition is that the pathloss value of the first signal measured by the entity is greater than (or not less than) a threshold value, then the condition is satisfied when the pathloss value of the measured first signal is less than (or not greater than) a threshold value (or greater than (or not less than) a threshold value); otherwise, the condition is not satisfied; the threshold value is obtained by receiving an instruction and/or preset;
>>>>>the condition of being the entity related to the monitoring of the AI/ML model used by the first type of method is that a Tx timing error (Tx TE) or Tx timing error group (TEG) of the first signal is less than (or not greater than) a threshold value; alternatively, in another example, the condition is that the Tx timing error (Tx TE) or Tx timing error group (TEG) of the first signal is greater than (or not less than) a threshold value; when the Tx timing error (Tx TE) or Tx timing error group (TEG) of the first signal is less than (or not greater than) a threshold value (or greater than (or not less than) a threshold value), the condition is satisfied, otherwise, the condition is not satisfied; the threshold value is obtained by receiving an instruction and/or preset;
>>>>>the condition of being the entity related to the monitoring of the AI/ML model used by the first type of method is that a reception timing error (Rx TE) or Rx TEG of the first signal is less than (or not greater than) a threshold value; alternatively, in another example, the condition is that the reception timing error (Rx TE) or Rx TEG of the first signal is greater than (or not less than) a threshold value; when the reception timing error (Rx TE) or Rx TEG of the first signal is less than (or not greater than) a threshold value (or greater than (or not less than) a threshold value), the condition is satisfied; otherwise, the condition is not satisfied; the threshold value is obtained by receiving an instruction and/or preset;
>>>>>the condition of being the entity related to the monitoring of the AI/ML model used by the first type of method is that a Tx and Rx TE or TEG of the first signal is less than (or not greater than) a threshold value; alternatively, in another example, the condition is that the Tx and Rx TE or TEG of the first signal is greater than (or not less than) a threshold value; when the Tx and Rx TE or TEG of the first signal is less than (or not greater than) a threshold value (or greater than (or not less than) a threshold value), the condition is satisfied, otherwise, the condition is not satisfied; the threshold value is obtained by receiving an instruction and/or preset;
>>>>>the condition of being the entity related to the monitoring of the AI/ML model used by the first type of method is that a Tx and Rx TE or TEG of the first signal is in a specific range; when the Tx and Rx TE or TEG of the first signal is in the specific range, the condition is satisfied; otherwise, the condition is not satisfied; the specific range is obtained by receiving an instruction and/or preset;
>>>>optionally, if the entity satisfies one or more of the above conditions, it may be called a valid entity, otherwise, it may be called an invalid entity;
>>>when one or more of the above trigger conditions occur no less than (greater than) N2 times, where N2 is a positive integer not less than 1, and N2 is obtained by receiving an instruction and/or preset, for example, a trigger condition counter reaches N2+1 times;

The first signal includes a reference signal for positioning (for example, a downlink positioning reference signal (PRS) and/or an uplink sounding reference signa (SRS) for positioning in a cellular wireless communication system, etc.) and/or the other reference signal in a wireless system, for example, a synchronization signal block (SSB) (or synchronization signal and physical broadcast channel (SS/PBCH) block) and/or a channel state information-reference signal (CSI-RS), a physical random access channel (PRACH) signal, an SRS for multiple-input and multiple-output (MIMO), etc.; measurement results of the first signal may be used to acquire input training information and/or input information in the operation part;

Optionally, when the first type of method includes N (N is a positive integer greater than 1) AI/ML models, one or more of the above trigger conditions may be used to judge whether to monitor M (M is a positive integer not greater than N) AI/ML models among them; alternatively, N and M may be numeral values pre-configured by a network device or dynamically configured (by DCI, MAC CE and/or high-level signaling);
>>performing monitoring trigger; optionally, the performing of the monitoring trigger may include one or more of the following operations:
>>>when the entity is a network-side entity (for example, a location management function (LMF) and/or a base station entity) and the monitoring of the AI/ML model of the first type of method is triggered, and a user equipment needs to perform and/or assist the monitoring of the AI/ML model of the first type of method, the network-side entity may indicate and/or activate to trigger the monitoring of the AI/ML model of the first type of method through an LTE positioning protocol (LPP) message and/or a radio resource control (RRC) configuration message and/or a media access control (MAC) control element (CE) and/or downlink control information (DCI), and the user equipment may receive the indication and/or activation to trigger the monitoring of the AI/ML model of the first type of method;
>>>when the entity is a user equipment and triggers the monitoring of the AI/ML model of the first type of method, and/or a network-side entity needs to perform and/or assist the monitoring of the AI/ML model of the first type of method, the UE may request the network-side entity to monitor the AI/ML model of the first type of method through a physical uplink control channel (PUCCH) and/or MAC CE and/or a physical random access channel (PRACH) and/or an LPP message; the UE may receive a feedback of the request from the network-side entity to determine whether to monitor the AI/ML model of the first type of method; the feedback includes the above indication and/or activation for indicating and/or activating the monitoring of the AI/ML model of the first type of method by the network-side entity;
>>>when a UE and/or a network-side entity triggers the monitoring of the AI/ML model of the first type of method, the UE and/or the network-side entity starts the monitoring of the AI/ML model of the first type of method by receiving an indication of a higher layer; this method is more suitable when both the deployment and monitoring of the first type of method are on the same entity;
>transmitting and/or receiving configuration information related to monitoring, which is optional; in this part, the entity A may perform transmitting and/or receiving of configuration information related to the monitoring of the AI/ML model of the first type of method, where the configuration information related to the monitoring of the AI/ML model of the first type of method includes one or more of:
>>configuration information of a second signal for AI/ML model monitoring (including a start position of a time-domain unit, the number of occupied time units, and a time-domain cycle/periodicity; a start position of a frequency-domain unit, the number of occupied frequency-domain units, etc.)
>>resource configuration information for reporting measurement results of the second signal (including a start position of a time-domain unit, the number of occupied time units, and a time-domain cycle/periodicity; a start position of a frequency-domain unit, the number of occupied frequency-domain units, etc.);

The second signal includes a reference signal for positioning (for example, a downlink positioning reference signal (PRS) and/or an uplink sounding reference signal (SRS) for positioning in a cellular wireless communication system, etc.) and/or the other reference signal in a wireless system, for example, a synchronization signal block (SSB) (or synchronization signal and physical broadcast channel (SS/PBCH) block) and/or a channel state information-reference signal (CSI-RS), a PRACH signal, an SRS for MIMO, etc. ; measurement results of the second signal may be used to acquire input training information and/or input information in the operation part; the second signal may be the same as the first signal, and/or configuration information of the second signal may be the same as configuration information of the first signal;
>>related information of a monitored model, including at least one or a combination of:
>>>composition of models of the first type of method, for example, the first type of method includes N3 AI/ML model parts (number and/or index information), for example, when N3=1, the first type of method has only one AI/ML model; when N3=2, the first type of method may be obtained by combining two AI/ML models; by analogy, N3 may be other positive integers, it is obtained by combining multiple AI/ML models; preferably, multiple AI/ML models in the first type of method may use the same input training data and/or different output training labels;
>>>>optionally, the model of the first type of method may be an AI/ML model that only needs to be monitored;
>>>a type of the AI/ML model of the first type of method, including: a type determined according to an AI method; and/or a type determined according to the number of floating point operands (FLOP) of a neural network model; and/or a type determined according to a latency requirement; and/or a type determined according to a required/supported data size (a size of a data set and/or a size of a data dimension); and/or a type determined according to a used operation (for example, a convolution and/or matrix operation);
>>>hyperparameter configuration information, including learning rate and/or number of layers and/or batch size and/or data set epoch times and/or clip value, etc.;
>>>a data set related parameter, including: a data type of a group of data; and/or the number of corresponding data type parameters (for example, a group of data for positioning includes N4 channel impulse response values, where the channel impulse response value is a data type and N4 is the number of the data type parameters), where N4 is obtained by receiving an instruction and/or preset; and/or the number of groups of data;
>>>>optionally, the size of the data set may be specific to a training part, and/or specific to a testing part, and/or common to the testing part and the training part;
>>>>optionally, the number of the data type parameters in the data set may be determined according to a certain condition; the condition may help to screen more suitable and effective input information and/or reduce signaling overhead; the certain condition may include one or more of:
>>>>>a channel impulse response value greater than (or not less than) a threshold value; the threshold value is obtained by receiving an instruction and/or preset; for example, there are total of 4096 channel impulse response values, and only N5 channel impulse response values are greater than the threshold value, then only the N5 channel impulse response values are transferred (transmitted and/or received); N5 does not exceed a maximum value Nmax, where N5 and Nmax are obtained by receiving an instruction and/or preset; and/or
>>>>>the first N6 channel impulse response values with the earliest arrival time and/or the first N6 channel impulse response values with the maximum power among all impulse responses, where N6 is obtained by receiving an instruction and/or preset;
>>>>>the channel impulse response value including a power value and/or arrival time of an arrival path;
>>>a weight parameter and/or bias parameter configuration, including initial values (for example, initial weight parameter and/or initial bias parameter setting obtained according to a certain criteria and/or initial weight parameter and/or initial bias parameter setting obtained according to received signaling) and/or updated values (for example, updated weight parameter and/or updated bias parameter values obtained according to training and/or updating and/or recovery), and specifically including one or more of:
>>>>initial weight parameter and/or initial bias parameter setting, including initial weight parameters and/or bias parameters obtained according to determined probability distribution; and/or
>>>>setting according to the received weight parameter configuration and/or bias parameter configuration, for example, weight parameters and/or bias parameters obtained by training or pre-training; such setting may be more suitable for online training or online training according to the first type of method obtained by pre-training; and/or
>>>>weight parameters and/or bias parameters obtained and/or updated according to training of an optimizer model and/or optimization strength and/or learning rate; for example, the updated value is obtained;
>>a related configuration of a measurement/monitoring gap (MG) and/or PRS processing window (PPW) for monitoring the AI/ML model, including a time length, a cycle/periodicity size and a time start position of the MG and/or PPW;
>>optionally, configuration information related to monitoring may be transmitted by an entity B, and/or transmitted by other entities (such as the entity A using the first type of method) and received by the entity B;
>>optionally, the above configuration information may be for a model of a monitored first type of method for or one or more AI/ML models of a monitored first type of method;
>obtaining monitoring data. In an example, in this part, the entity A may obtain the monitoring data according to the obtained configuration information related to the monitoring of the AI/ML model. Alternatively, the entity A may obtain the monitoring data without having to be based on the configuration information related to the monitoring of the AI/ML model. In this part:
>>the obtained monitoring data includes one or more of:
>>>information related to data (for example, model input information) of the (monitored) AI/ML model, including one or more of:
>>>>data type, such as channel impulse response (CIR); and/or;
>>>>data size, such as 256 or 8 or 1, and/or;
>>>>data distribution (a type, mean and/or variance of the distribution), and/or
>>>>data quality, such as the number (or ratio) of data higher than or better than a certain threshold value; take CIR as an example, the number (or ratio) of CIR higher than a certain threshold value obtained by measuring the second signal;
>>>>optionally, the data may be replaced with valid data or data satisfying a certain condition;
>>>information related to inference results (for example, model output information) of the (monitored) AI/ML model:
>>>>location information, such as coordinates; for example, it is suitable when the AI/ML model is directly used for positioning;
>>>>measured values, such as time-related measured values (such as reference signal time difference (RSTD), relative time of arrival (RTOA), etc.), angle-related measured values (such as angle of arrival (AOA), angle of departure (AOD), etc.) and phase-related measured values (such as phase difference of arrival (PDOA), etc.); for example, it is suitable shen the AI/ML model assists in positioning;
>>>measured RSRP, RSRQ; for example, RSRP, RSRQ obtained by measuring the second signal;
>>>measured signal-to-noise ratio (SNR), signal to interference plus noise ratio (SINR); for example, SNR, SINR obtained by measuring the second signal;
>>the method of obtaining the monitoring data includes one or a combination of more of:
>>>by receiving reports from other entities, for example, when the entity A is a network-side entity, receiving a report including the monitoring data from a UE;
>>>being obtained by measuring the second signal; for example, when the entity A is a network-side entity, by measuring an SRS from a UE; or, for example, when the entity A is a UE, by measuring a PRS from a network-side entity;
>judging to obtain a monitoring result; optionally, in this part, the monitoring result may be obtained according to the obtained monitoring data, or the monitoring result may be obtained without depending on the obtained monitoring data. The obtaining of the monitoring result may include one or more of the following operations:
>>judging based on a certain event; that is, when the certain event occurs, the monitoring result is judged to pass; otherwise, the monitoring result is judged not to pass; specifically, the certain event includes one or more of:
>>>when the obtained monitoring data satisfies a required threshold value, where the threshold value is obtained by receiving an instruction and/or preset; for example, if the obtained monitoring data is positioning information, if a difference between a positioning location in the monitoring data and a real positioning location (or an expected positioning location, or a positioning location obtained by the other methods, etc.) is not greater than (or less than) a certain threshold value, the monitoring data is considered to satisfy the required threshold value; optionally, the threshold value may relate to an uncertainty range of the location information, for example, when the above difference is within the uncertainty range, the obtained monitoring data is considered to satisfy the required threshold value; optionally, for example, when the obtained monitoring data is the AI/ML model input information, and the number and/or type of the input information in the monitoring data satisfies the required threshold value, the obtained monitoring data may be considered to satisfy the required threshold value, where the threshold value may be obtained by receiving an instruction and/or preset; for example, the number and/or type of the input information in the monitoring data satisfying the required threshold value may include that the entity A obtains enough channel impulse response information, specifically, it may include at least one of:
>>>>obtaining input information provided by not less than or greater than N7 devices, where N7 is obtained by receiving an instruction and/or preset; and/or;
>>>>obtaining measurement results of not less than or greater than N8 second signals, where N8 is obtained by receiving an instruction and/or preset; and/or;
>>>>obtaining not less than or greater than N9 pieces of CIR/RSRP/angle related information (e.g., AOA, AOD, etc.)/phase related information (e.g., PDOA, etc.), where N9 is obtained by receiving an instruction and/or preset;
>>judging based on an operating duration and/or the number of operating times of the model. For example, the monitoring result can be obtained based on the operating duration and/or the number of operating times of the model satisfying a second condition and/or the number of occurrences of the events in the judgment based on the certain event satisfying a third condition. The operating duration and/or the number of operating times of the model satisfying the second condition includes that the operating duration does not exceed a first time threshold and/or the number of operating times do not exceed a first threshold for number of times. The number of occurrences of the events satisfying the third condition includes that the number of occurrences of the events does not exceed a second threshold for number of times.

In an example, the monitoring result may be obtained based on the counting and/or timing related to the operating of the model and/or the counting related to the above number of occurrences of the events by means of a timer or a counter, which may include one or more of the following conditions and operation combinations:
>>>when determining to use the first type of method or receiving an instruction to use the first type of method, an operating counter for the first type of method is initially set to 1 and/or a timer for monitoring the model of the first type of method is started;
>>>when the event is judged to occur based on the above certain event, a first operating counter is incremented by 1 and/or a first timer for monitoring the AI/ML model stops counting (or is judged to be expired);
>>>when an operating cycle is completed, or when the model runs for first times or produces the ninth number of output results, a second operating counter is incremented by 1 and/or a second timer for monitoring the AI/ML model stops counting (or is judged to be expired), where the operating cycle includes X time units, which may be a configured and/or predefined number and/or determined according to the number of time units required for obtaining Y monitoring data, where Y is configured or predefined;
>>>when a count value of the first operating counter does not exceed the second threshold for number of times, or when the first timer is still operating or counting, or a count value of the second operating counter does not exceed the first threshold for number of times, or when the second timer is still operating or counting (for example, the first time threshold has not been reached), the monitoring result is judged to pass, otherwise it is judged not to pass. The first threshold for number of times, the second threshold for number of times and the first time threshold may be a maximum value of the first counter, a maximum value of the second counter and a maximum value of the second timer respectively, and the values may be configured, preset or received from other nodes. For example, when a value of any of the above counters counter_value does not reach or is not greater than or less than a set maximum value max (for example, counter_value=max+1), or any of the above timers does not stop counting or expire, the monitoring result is judged to pass; otherwise, the monitoring result is judged not to pass;
>performing an operation corresponding to the monitoring result; in this part, according to the monitoring result obtained by judgment, the corresponding operation is performed; optionally, in this part, one or more of the following operations may be included:
>>when the monitoring result is judged to pass, the entity A continues using the monitored one or more AI/ML models;
>>when the result is judged not to pass, the entity A can perform at least one of:
>>>terminating the use of the monitored one or more AI/ML models; and/or
>>>initiating fine-tuning of the monitored one or more AI/ML models; and/or;
>>>initiating switching of the monitored one or more AI/ML models;
>>>optionally, when the number of times of judging the result not to pass reaches (or continuously reaches) W times, performing the above operations; otherwise, the entity A continues using the monitored one or more AI/ML models;
>optionally, the entity A and/or the entity B may be a network entity, a user equipment, or an entity supporting sidelink communication.
>optionally, the first type of method described in the present disclosure may be replaced by one or more AI/ML models in the first type of method;

The above exemplary embodiments are only illustrative, and those skilled in the art can make various adaptive changes within the protection scope of the present disclosure.

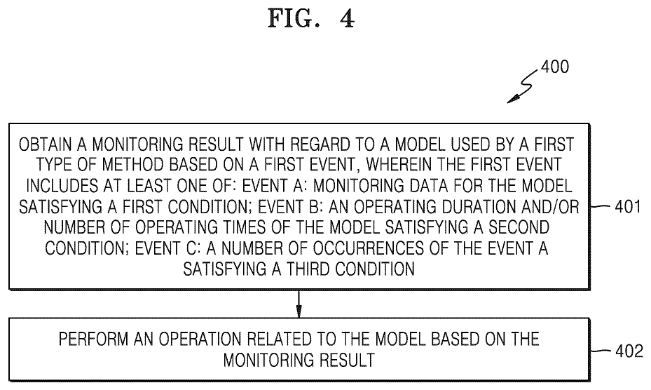

FIG. 4 illustrates a schematic diagram of a method 400 according to an embodiment of the present disclosure. As shown in FIG. 4, the method 400 includes the following steps:
step 401: a node obtains a monitoring result with regard to a model used by a first type of method based on a first event; and
step 402: the node performs an operation related to the model based on the monitoring result.

The first event includes at least one of: event A: monitoring data for the model satisfying a first condition; event B: an operating duration and/or the number of operating times of the model satisfying a second condition; event C: the number of occurrences of the event A satisfying a third condition. The node may be an entity deployed with a machine learning model, for example, a user equipment (UE), a base station entity, a network-side entity, and the like.

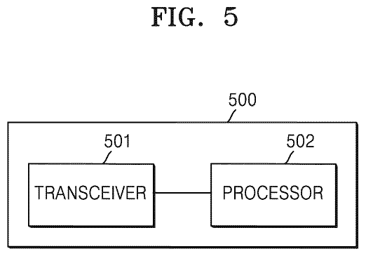

Referring to FIG. 5, the present disclosure also provides an example block diagram of an electronic device 500 according to an embodiment of the present disclosure. The electronic device includes a transceiver 501 and a controller 502. The transceiver 501 is configured to transmit and/or receive data or signals, and the controller 502 is configured to control such that the electronic device performs the methods or operations according to at least one of various aspects of the embodiments of the present disclosure. Optionally, the electronic device may further include a memory (not shown). The memory may have computer-executable instructions stored thereon, and when the instructions are executed by the controller 502, the electronic device can perform at least one method corresponding to the above various embodiments of the present disclosure.

The above description is only the preferred embodiment of the present disclosure, and is not used to limit the present disclosure. Any modification, equivalent re-placement, improvement, etc. made within the spirit and principle of the present disclosure should be included in the scope of protection of the present disclosure.

Those skilled in the art will understand that the present disclosure may include devices for performing one or more of the operations described in the present disclosure. These devices can be specifically designed and manufactured for required purposes, or they can also include known devices in general-purpose computers. These devices have computer programs stored therein, which are selectively activated or reconfigured. Such computer programs may be stored in a device (e.g., computer) readable medium or in any type of media suitable for storing electronic instructions and respectively coupled to a bus, where the computer readable medium includes but is not limited to any type of disk (including floppy disk, hard disk, optical disk, CD-ROM, and magneto-optical disk), ROM (Read-Only Memory), RAM (Random Access Memory), EPROM (Erasable Programmable Read-Only Memory), EEPROM (Electrically Erasable Programmable Read-Only Memory), flash memory, magnetic card or optical card. That is, the readable medium includes any medium in which information is stored or transmitted by a device (e.g., a computer) in a readable form.

It will be understood by those skilled in the art that each block in these structure diagrams and/or block diagrams and/or flow diagrams and combinations of blocks in these structure diagrams and/or block diagrams and/or flow diagrams can be implemented by computer program instructions. It can be understood by those skilled in the art that these computer program instructions can be provided to a general-purpose computer, a professional computer or a processor of other programmable data processing methods for implementation, so that the schemes specified in the block or blocks of the structure diagrams and/or block diagrams and/or flow diagrams disclosed in the present disclosure may be performed by the computer or the processor of other programmable data processing methods.

Those skilled in the art can understand that the steps, approaches and schemes in various operations, methods and flows discussed in the present disclosure may be alternated, changed, combined or deleted. Further, other steps, approaches and schemes in the various operations, methods and flows already discussed in the present disclosure may also be alternated, changed, rearranged, decomposed, combined or deleted. Further, the steps, approaches and schemes in various operations, methods and flows disclosed in the present disclosure may also be alternated, changed, rearranged, decomposed, combined or deleted.

The above description is only part of the implementations of the present disclosure. It should be pointed out that for those skilled in the art, several improvements and embellishments can be made without departing from the principles of the present disclosure, and these improvements and embellishments should also be regarded as the scope of protection of the present disclosure.

1. A method performed by a node in a communication system, the method comprising:
obtaining a monitoring result with regard to a model used by a first type of method based on a first event; and
performing an operation related to the model based on the monitoring result,
wherein the first event includes at least one of:
event A: monitoring data for the model satisfying a first condition;
event B: an operating duration and/or a number of operating times of the model satisfying a second condition; or
event C: a number of occurrences of the event A satisfying a third condition.

2. The method of claim 1, wherein the operating duration and/or the number of operating times of the model satisfying the second condition includes:
the operating duration not exceeding a first time threshold, and/or
the number of operating times not exceeding a first threshold for number of times.

3. The method of claim 1, wherein the number of occurrences of the event A satisfying the third condition includes:
the number of occurrences of the event A not exceeding a second threshold for number of times.

4. The method of claim 1, wherein the monitoring data includes at least one of:
information related to model input information;
information related to model output information;
a reference signal received power (RSRP) and/or a reference signal received quality (RSRQ) obtained by measuring a second signal; or
a signal-to-noise ratio (SNR) and/or a signal to interference plus noise ratio (SINR) obtained by measuring the second signal,
wherein the information related to the model input information includes at least one of: a data type; a data size; a data distribution; or a data quality including a number or ratio of the data higher than a certain threshold value, and
wherein the information related to the model output information includes at least one of: location information; or a measured value related to a location.

5. The method of claim 1, wherein the node obtains the monitoring data by:
obtaining the monitoring data through reports received from other nodes; and/or
obtaining the monitoring data by measuring a second signal.

6. The method of claim 1, wherein the monitoring data satisfying the first condition includes at least one of:
a difference between a positioning location corresponding to positioning information included in the monitoring data and a predetermined positioning location being not greater than a second threshold, or the difference being within an uncertainty range of location information;
a number of data corresponding to model input information included in the monitoring data satisfying a threshold of number and/or data type satisfying a type group;
the monitoring data including input information on the model provided by not less than a first number of entities;
the monitoring data including not less than a second number of measurement results for a second signal; or
the monitoring data including not less than a third number of channel impulse response CIR/RSRP/angle related information/phase related information.

7. The method of claim 1, wherein the monitoring data is obtained based on configuration information related to monitoring the model, and wherein the configuration information includes at least one of:
configuration information of a second signal for monitoring the model;
resource configuration information for reporting a measurement result of the second signal;
monitored model related information; or
configuration information of a measurement/monitoring gap (MG) and/or a positioning reference signal (PRS) processing window (PPW) for monitoring the model.

8. The method of claim 7, wherein the monitored model related information includes at least one of:
information related to composition of models of the first type of method or models that need to be monitored, including a number and/or index information of the models;
a type of the model of the first type of method;
hyperparameter configuration information;
a data set related parameter; or
a weight parameter and/or bias parameter configuration.

9. The method of claim 7, wherein monitoring the model is triggered based on at least one of:
the first type of method and/or at least one of models of the first type of method being valid;
a first trigger condition being satisfied; or
a number of times the first trigger condition is satisfied being not less than a fourth number,
wherein the first trigger condition includes at least one of:
an RSRP value of a measured first signal being not less than a first threshold value;
a pathloss of the measured first signal being not greater than a second threshold value; or
a number of entities related to monitoring the model being not less than a fifth number.

10. The method of claim 9, wherein the entities related to monitoring the model include an entity satisfying at least one of:
having known location information;
reporting that it has a capability as an entity for monitoring the model;
a state indicator as the entity for monitoring the model being active or available;
being in a coverage area of a same cell or cell group as the node;
having a same serving cell as the node and/or being in the same cell group as a serving cell of the node;
being capable of receiving and measuring a first signal and/or transmitting the first signal;
the measured first signal satisfying a condition related to a signal characteristic; or
a transmission and/or reception characteristic of the first signal satisfying a condition related to a transmission error and/or reception error of a signal.

11. The method of claim 1, wherein performing the operation related to the model based on the monitoring result comprises:
when the monitoring result is that monitoring does not pass, or when a number of times in which the monitoring result is that the monitoring does not pass reaches an eighth number, performing at least one of:
terminating use of the model;
initiating model fine-tuning; or
initiating model switching.

12. A node comprising:
a transceiver;
a controller coupled with the transceiver and configured to perform operations comprising:
obtaining a monitoring result with regard to a model used by a first type of method based on a first event; and
performing an operation related to the model based on the monitoring result,
wherein the first event includes at least one of:
event A: monitoring data for the model satisfying a first condition;
event B: an operating duration and/or a number of operating times of the model satisfying a second condition; or
event C: a number of occurrences of the event A satisfying a third condition.

13. A non-transitory computer-readable medium storing computer-executable instructions which, when executed by a processor, cause the processor to perform operations comprising:
obtaining a monitoring result with regard to a model used by a first type of method based on a first event; and
performing an operation related to the model based on the monitoring result,
wherein the first event includes at least one of:
event A: monitoring data for the model satisfying a first condition;
event B: an operating duration and/or a number of operating times of the model satisfying a second condition; or
event C: a number of occurrences of the event A satisfying a third condition.
